(19) United States
(12) Patent Application Publication
(10) Pub. No.: US 2025/0095130 A1
(43) Pub. Date: Mar. 20, 2025

(54) WELD QUALITY INSPECTION SYSTEM, WELD QUALITY INSPECTION METHOD, AND BATTERY

(71) Applicant: Isuzu Motors Limited, Yokohama-shi (JP)

(72) Inventor: Kenichiro TSUDA, Fujisawa-shi (JP)

(73) Assignee: Isuzu Motors Limited, Yokohama-shi (JP)

(21) Appl. No.: 18/884,159

(22) Filed: Sep. 13, 2024

(30) Foreign Application Priority Data
Sep. 14, 2023 (JP) 2023-149127

(51) Int. Cl. G06T 7/00; H01M 10/48; H01M 50/516

(52) U.S. Cl. CPC G06T 7/0004; H01M 10/48; H01M 50/516; G06T 2207/30152

(57) ABSTRACT

Provided is a weld quality inspection system of the present disclosure that includes: an imaging apparatus that images a heat sensitive paint applied to a conductive member that is electrically connected to a plurality of battery cells by a weld; and a determination processing part that determines a quality of the weld based on an image obtained by the imaging apparatus.

### CROSS REFERENCE TO RELATED APPLICATIONS

This application claims the benefit of priority of Japanese Patent Application No. 2023-149127, filed on Sep. 14, 2023, the disclosure of which including the specification, drawings and abstract is incorporated herein by reference in its entirety.

### TECHNICAL FIELD

The present disclosure relates to a weld quality inspection system, a weld quality inspection method, and a battery.

### BACKGROUND ART

A battery used in an electric vehicle or the like is generally embodied in the form of a battery pack. In the battery pack, a number of battery cells are welded to a bus bar via a metal wire or a metal tab, and thus, a number of battery cells are connected in series and/or in parallel. As a result, a high-voltage and high-capacitance battery pack is realized. Such a battery pack is described in, for example, Patent Literature (hereinafter referred to as “PTL”) 1.

### CITATION LIST

### Patent Literature

### PTL 1

Japanese Patent Publication Laid-Open No. 2023-45155

### SUMMARY OF INVENTION

### Technical Problem

Incidentally, the weld quality affects the performance of a battery pack. Accordingly, it is required to inspect the weld quality with high accuracy. For example, in a case where there is a defect in a weld or insufficient weld strength, it is required to surely detect the defect in the weld or the insufficient weld strength.

The present disclosure was made in view of the above points, and provides a weld quality inspection system, a weld quality inspection method, and a battery each capable of inspecting the weld quality with high accuracy.

### Solution to Problem

One aspect of a weld quality inspection system of the present disclosure includes: an imaging apparatus that images a heat sensitive paint applied to a conductive member that is electrically connected to a plurality of battery cells by a weld; and a determination processing part that determines a quality of the weld based on an image obtained by the imaging apparatus.

One aspect of a weld quality inspection method of the present disclosure includes: imaging a heat sensitive paint applied to a conductive member that is electrically connected to a plurality of battery cells by a weld; and determining a quality of the weld based on an image imaged in the imaging.

One aspect of a battery of the present disclosure includes: a battery cell; a conductive member that is electrically connected to the battery cell by a weld; and a heat sensitive paint applied to the conductive member.

### Advantageous Effects of Invention

According to the present disclosure, it is possible to provide a weld quality inspection system, a weld quality inspection method, and a battery each capable of inspecting the weld quality with high accuracy.

### BRIEF DESCRIPTION OF DRAWINGS

FIG. 1 illustrates how welded portions between a battery cell and a bus bar in a battery look like;

FIG. 2A illustrates how heat sensitive paints are applied to the bus bar;

FIG. 2B illustrates how the heat sensitive paints change color when normal welding is performed;

FIG. 2C illustrates how the heat sensitive paints change color when a welding defect occurs; and

FIG. 3 is a schematic diagram illustrating a schematic configuration of a weld quality inspection system for a battery according to an embodiment.

### DESCRIPTION OF EMBODIMENTS

The inventor of the present invention has focused on the fact that a conventional laser welding machine detects the weld quality based on reflected light of laser, the temperature of laser, fume generation, and/or the like, but the detection accuracy thereof cannot be said to be high enough. It is thought that one of the causes lies in performing temperature detection based on infrared light. More specifically, it is because infrared light includes reflected light of laser as well, and it is difficult to separate the reflected light.

The inventor of the present invention has found a configuration in which the quality of a weld is inspected without depending on infrared light, thereby arriving at the present disclosure. One characteristic of the present disclosure is that a heat sensitive paint is applied to a conductive member, the heat sensitive paint is imaged by a camera, and the quality of a weld is determined based on an image obtained by the camera. Thus, it is possible to inspect the weld quality with high accuracy.

Hereinafter, an embodiment of the present invention will be described with reference to the accompanying drawings.

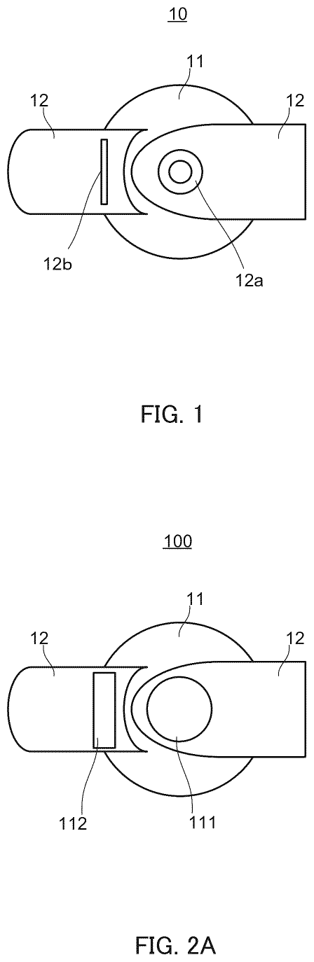

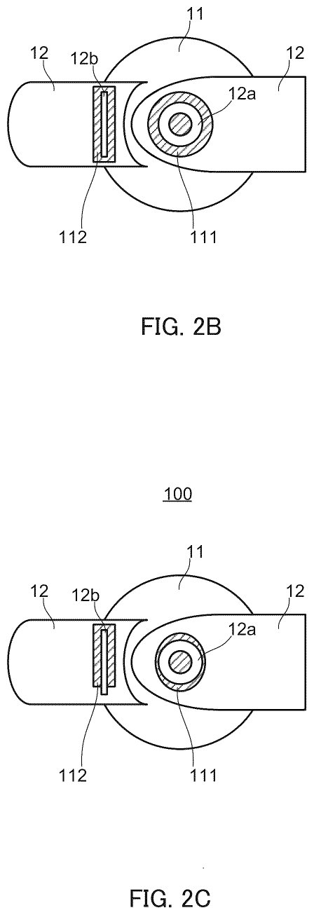

FIG. 1 illustrates how welded portions between battery cell 11 and bus bar 12 in battery 10 look like. FIGS. 2A to 2C are diagrams provided for describing the embodiment. Each of FIGS. 1 and 2A to 2C is a top view illustrating how welds in one battery cell 11 look like. In the actual battery, approximately several thousand battery cells 11, for which FIGS. 1 and 2A to 2C illustrate one battery cell 11, are connected in series and parallel via bus bar 12.

As illustrated in FIG. 1, battery cell 11 is welded to bus bar 12 at positive electrode weld part 12a and negative electrode weld part 12b. Specifically, laser light is emitted from the front side of the paper surface of bus bar 12 to heat bus bar 12, and thus, the rear side of bus bar 12 melts, and bus bar 12 and battery cell 11 are welded. Battery cell 11 is a lithium-ion battery having a cylindrical shape.

Next, the configuration of the embodiment will be described using FIGS. 2A to 2C. As illustrated in FIG. 2A, in battery 100 of the present embodiment, heat sensitive paints 111 and 112 are applied to bus bar 12. Heat sensitive paints 111 and 112 are applied to at least the peripheries of the weld parts. Specifically, heat sensitive paint 111 is applied to a region around and including positive electrode weld part 12a, and heat sensitive paint 112 is applied to a region around and including negative electrode weld part 12b.

Heat sensitive paints 111 and 112 change color depending on the temperature. When heat is applied to at least positive electrode weld part 12a and negative electrode weld part 12b, heat sensitive paints 111 and 112 change color in response to the heat.

FIGS. 2B and 2C illustrate how heat sensitive paints 111 and 112 change color by welds. The shaded regions represent regions in which heat sensitive paints 111 and 112 change color. FIG. 2B illustrates how heat sensitive paints 111 and 112 change color when normal welding is performed. Heat sensitive paint 111 around positive electrode weld part 12a changes color evenly, and heat sensitive paint 112 around negative electrode weld part 12b changes color evenly.

FIG. 2C illustrates how heat sensitive paints 111 and 112 change color when abnormal welding is performed (when a welding defect occurs), and heat sensitive paint 111 around positive electrode weld part 12a changes color unevenly, and heat sensitive paint 112 around negative electrode weld part 12b changes color unevenly.

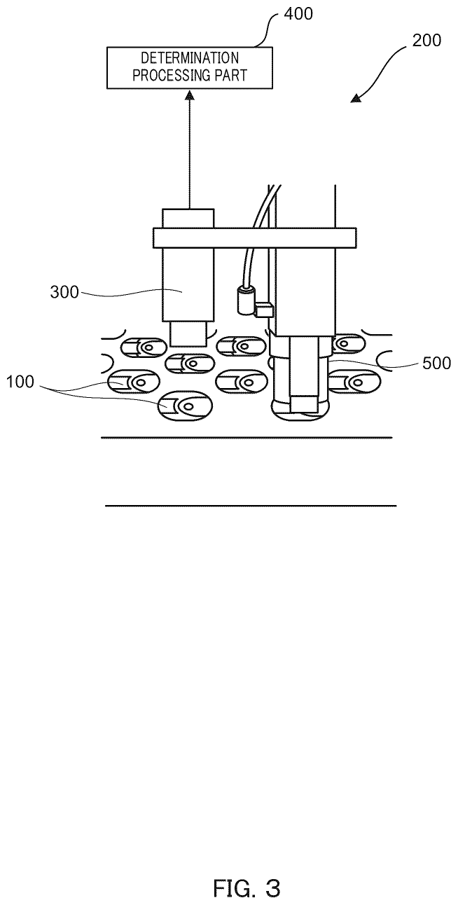

FIG. 3 is a schematic diagram illustrating a schematic configuration of weld quality inspection system 200 for a battery according to the present embodiment. Weld quality inspection system 200 includes: camera 300 that images heat sensitive paints 111 and 112; and determination processing part 400 that determines the quality of a weld based on an image obtained by camera 300.

Specifically, camera 300 images heat sensitive paints 111 and 112 after welding. In the example of FIG. 3, camera 300 is coupled to a head of laser welding machine 500, and images heat sensitive paints 111 and 112 of battery 100 after welding by laser welding machine 500.

Determination processing part 400 analyzes color changes in heat sensitive paints 111 and 112 by image processing, and determines the quality of a weld based on how heat sensitive paints 111 and 112 change color. This determination is performed based on, for example, the following determination criteria (i) to (v).
(i) Determination processing part 400 determines whether a color change region covers the periphery of a weld part completely, and in a case where the color change region does not cover the periphery of the weld part completely, determination processing part 400 determines the case as a welding defect. For example, in FIG. 2C, the color change region at heat sensitive paint 112 does not cover negative electrode weld part 12b completely, which determination processing part 400 therefore determines as a welding defect.
(ii) Determination processing part 400 determines whether the width of a color change region surrounding a weld part is larger than a predetermined value, and in a case where there is a color change portion having a width smaller than the predetermined value, determination processing part 400 determines the case as a welding defect. For example, in FIG. 2C, the width of a part of the color change region at heat sensitive paint 111 around positive electrode weld part 12a is smaller than the predetermined value, which determination processing part 400 therefore determines as a welding defect.
(iii) Determination processing part 400 determines alight color change as a welding defect.
(iv) Determination processing part 400 determines color unevenness, which occurs in a color change region, as a welding defect.
(v) Determination processing part 400 determines the area of a color change region, which is smaller than a predetermined value, as a welding defect.

The determination criteria (i) to (v) described above may be used alone, or two or more thereof may be used in combination. Further, determination criteria other than (i) to (v) described above may also be used.

In practice, determination processing part 400 includes a central processing unit (CPU), a random access memory (RAM), a read only memory (ROM), and the like as the main components. The CPU reads a program according to a processing content from the ROM, develops the program in the RAM, and cooperates with the developed program to perform the determination processing described above. Note that, determination processing part 400 may be formed entirely or partially of a hard-wired circuit such as an application specific integrated circuit (ASIC) or a field-programmable gate array (FPGA).

The determination result of determination processing part 400 is presented to the user by a display part (not illustrated), a speaker (not illustrated), and/or the like.

As described above, according to the present embodiment, weld quality inspection system 200 includes: an imaging apparatus (camera 300) that images heat sensitive paints 111 and 112 applied to a conductive member (bus bar 12) that is electrically connected to a plurality of battery cells 11 by a weld; and determination processing part 400 that determines a quality of the weld based on an image obtained by the imaging apparatus (camera 300).

Thus, it is possible to realize weld quality inspection system 200 that is capable of inspecting the weld quality with high accuracy.

The embodiment described above is only illustration of an exemplary embodiment for implementing the present disclosure, and the technical scope of the present invention shall not be construed limitedly thereby. That is, the present disclosure can be implemented in various forms without departing from the gist or the main features thereof.

In addition to the embodiment described above, heat sensitive paints 111 and 112 having a heat sensibility that varies depending on the distance from the weld part (positive electrode weld part 12a or negative electrode weld part 12b) may be used. For example, heat sensitive paint 111 may be configured to have a higher heat sensibility as the distance from positive electrode weld part 12a increases, and heat sensitive paint 112 may be configured to have a higher heat sensibility as the distance from negative electrode weld part 12b increases.

Here, as the distance from the weld part (positive electrode weld part 12a or negative electrode weld part 12b) increases, an increase in temperature due to a weld decreases. Accordingly, in a case where heat sensitive paints 111 and 112 having a uniform heat sensibility are used, the degree of a color change becomes smaller as the distance from the weld part (positive electrode weld part 12a or negative electrode weld part 12b) increases. For this reason, in a case where heat sensitive paints 111 and 112 having a uniform heat sensibility are used, it is necessary to perform determination processing in anticipation thereof. In contrast, when heat sensitive paint 111 is configured to have a higher heat sensibility as the distance from positive electrode weld part 12a increases and heat sensitive paint 112 is configured to have a higher heat sensibility as the distance from negative electrode weld part 12b increases, a decrease in a color change due to the distance is suppressed, and thus, it is possible to simplify the processing in determination processing part 400.

In the embodiment described above, a case where the conductive member that is electrically connected to battery cell 11 by a weld is bus bar 12 and heat sensitive paints 111 and 112 are applied to bus bar 12 has been described, but the present disclosure is not limited thereto. For example, the conductive member may include bus bar 12 and a wire (not illustrated) that connects battery cell 11 to bus bar 12, and the heat sensitive paint may be applied to bus bar 12 to battery cell 11. Thus, it is possible to inspect the quality of a weld between bus bar 12 and the wire (not illustrated) and the quality of a weld between battery cell 11 and the wire (not illustrated) based on a color change in the heat sensitive paint.

### INDUSTRIAL APPLICABILITY

The present disclosure may be applied to a system that inspects the weld quality for a battery used in an electric vehicle or the like, for example.

### REFERENCE SIGNS LIST

10, 100 Battery
11 Battery cell
12 Bus bar
12a Positive electrode weld part
12b Negative electrode weld part
111, 112 Heat sensitive paint
200 Weld quality inspection system
300 Camera
400 Determination processing part

1. A weld quality inspection system, comprising:
an imaging apparatus that images a heat sensitive paint, the heat sensitive paint being applied to a conductive member that is electrically connected to a plurality of battery cells by a weld; and
a determination processing part that determines a quality of the weld based on an image obtained by the imaging apparatus.

2. The weld quality inspection system according to claim 1, wherein
the heat sensitive paint is applied to at least a periphery of a weld part.

3. The weld quality inspection system according to claim 1, wherein
the heat sensitive paint has a heat sensibility that varies depending on a distance from a weld part.

4. The weld quality inspection system according to claim 1, wherein:
the conductive member is a bus bar, and
the heat sensitive paint is applied to at least the bus bar.

5. The weld quality inspection system according to claim 1, wherein:
the conductive member includes a bus bar and a wire that connects the plurality of battery cells to the bus bar, and
the heat sensitive paint is applied to the bus bar and the plurality of battery cells.

6. A weld quality inspection method, comprising:
imaging a heat sensitive paint, the heat sensitive paint being applied to a conductive member that is electrically connected to a plurality of battery cells by a weld; and
determining a quality of the weld based on an image imaged in the imaging.

7. A battery, comprising:
a battery cell;
a conductive member that is electrically connected to the battery cell by a weld; and
a heat sensitive paint applied to the conductive member.

8. The battery according to claim 7, wherein
the heat sensitive paint is applied to at least a periphery of a weld part.

9. The battery according to claim 7, wherein
the heat sensitive paint has a heat sensibility that varies depending on a distance from a weld part.

10. The battery according to claim 7, wherein:
the conductive member is a bus bar, and
the heat sensitive paint is applied to at least the bus bar.

11. The battery according to claim 7, wherein:
the conductive member includes a bus bar and a wire that connects the battery cell to the bus bar, and
the heat sensitive paint is applied to the bus bar and the battery cell.
